(19) United States
(12) Patent Application Publication
(10) Pub. No.: US 2010/0318420 A1
(43) Pub. Date: Dec. 16, 2010

(54) APPARATUS AND METHOD FOR PROVIDING MEDIA ADVERTISEMENT SERVICE USING HUMAN BODY COMMUNICATION

(75) Inventors: Duck-Gun Park, Daejon (KR); Sung-Weon Kang, Daejon (KR); Chang-Hee Hyoung, Daejon (KR); Jin-Bong Sung, Daejon (KR); Jung-Hwan Hwang, Daejon (KR); Sung-Eun Kim, Seoul (KR); Jin-Kyung Kim, Daejon (KR); In-Gi Lim, Daejon (KR); Hyung-ll Park, Daejon (KR); Jung-Bum Kim, Daejon (KR); Kyung-Soo Kim, Daejon (KR)

Correspondence Address: AMPACC Law Group, 3500 188th Street S.W., Suite 103, Lynnwood, WA, 98037, US

(73) Assignee: ELECTRONICS AND TELECOMMUNICATIONS RESEARCH INSTITUTE, DAEJON (KR)

(21) Appl. No.: 12/518,091

(22) PCT Filed: Dec. 5, 2007
(86) PCT No.: PCT/KR07/06281

§ 371 Date: May 28, 2010

(30) Foreign Application Priority Data
Dec. 6, 2006 (KR) 10-2006-0123237
Nov. 5, 2007 (KR) 10-2007-0112210

(51) Int. Cl. G06Q 30/00

(52) U.S. Cl. 705/14.49

(57) ABSTRACT

There is provided an apparatus for providing a media advertisement service using human body communication, including: conductive contact part for contact with a human body; a control part configured to detect human body contact of a user with the conductive contact part and acquire user-contact-associated contents, the user-contact-associated-contents being contents associated with an advertisement selected by the human body contact of the user; and a human body communication part configured to convert the acquired user-contact-associated contents into a signal for human body communication and send the signal to a user terminal via the conductive contact part and a user's body.

### TECHNICAL FIELD

The present invention relates to an apparatus and method for providing a media advertisement service using human body communication; and, more particularly, to an apparatus and method for providing a media advertisement service using human body communication, which is configured to maximize an advertisement effect by providing a user, i.e., a user terminal, with various contents associated with an advertisement in which the user is interested through human body communication when the user contacts an advertising medium, e.g., a poster or an electronic display board of the advertisement.

This work was supported by the IT R&D program of MIC/IITA [2006-S-072-01, “Controller SoC for Human Body Communications”].

### BACKGROUND ART

Recent technology development and diversification of a social structure have led to emergence of various products or services. As technologies are being generalized and equalized, advertisements are considered increasingly important in selling the products or services.

However, most of general advertisements are limited to a message or a still image on a printing medium or an electronic display board, or a moving image played back on various image media such as a TV.

General advertisement technologies have limitations of lack of interaction with a user since an advertisement delivers a message unilaterally. Also, contents associated with an advertisement are limited in kinds and places where an advertising medium is placed.

That is, the general advertisement technologies have the following limitations: lack of interaction with a user due to unilateral message delivery, lack of diversity in advertisement-associated contents, and advertising limitations caused by a spatial limitation of an advertising medium.

### DISCLOSURE OF INVENTION

### Technical Problem

An embodiment of the present invention is directed to providing an apparatus and method for providing a media advertisement service using human body communication, which is configured to maximize an advertisement effect by providing a user, i.e., a user terminal, with various contents associated with an advertisement in which the user is interested through human body communication when the user contacts an advertising medium, e.g., a poster or an electronic display board of the advertisement.

Other objects and advantages of the present invention can be understood by the following description, and become apparent with reference to the embodiments of the present invention. Also, it is obvious to those skilled in the art of the present invention that the objects and advantages of the present invention can be realized by the means as claimed and combinations thereof.

### Technical Solution

In accordance with an aspect of the present invention, there is provided an apparatus for providing a media advertisement service using human body communication, including: conductive contact part for contact with a human body; a control part configured to detect human body contact of a user with the conductive contact part and acquire user-contact-associated contents, the user-contact-associated-contents being contents associated with an advertisement selected by the human body contact of the user; and a human body communication part configured to convert the acquired user-contact-associated contents into a signal for human body communication and send the signal to a user terminal via the conductive contact part and a user's body.

In accordance with another aspect of the present invention, there is provided a method for providing a media advertisement service using human body communication, including the steps of: detecting human body contact of a user with an advertising medium; acquiring user-contact-associated contents when the user's contact is detected, the user-contact-associated contents being contents associated with an advertisement selected by the user's contact; and converting the acquired user-contact-associated contents into a signal for human body communication and sending the signal to a user terminal through human body communication.

### ADVANTAGEOUS EFFECTS

In accordance with embodiments of the present invention, as a user contacts an advertising medium providing an advertisement which a user is interested in, the user can download various advertisement-associated contents from the advertising medium through human body communication, thereby maximizing an advertising effect.

For example, as the user contacts an advertising board of a movie poster in which the user is interested, the user can download associated publicity contents through human body communication and plays back the contents for 24 hours. Since the interested user is immediately provided with associated information, an interest in the corresponding advertisement can be increased.

In accordance with embodiments of the present invention, reaction of users to an advertisement can be statistically predicted on the basis of records of users' contact with an advertising board.

In accordance with embodiments of the present invention, various personalized entertainments can be offered to, e.g., consumers who are waiting for vehicles such as buses or subways.

In accordance with embodiments of the present invention, a user can acquire associated information only by contacting, e.g., an advertising board without requiring a special method to acquire, so that convenience in use can be improved.

### BRIEF DESCRIPTION OF THE DRAWINGS

FIGS. 1 and 2 are views for explaining a media advertisement service using human body communication in accordance with an embodiment of the present invention.

FIG. 3 is a block diagram of an apparatus for providing a media advertisement service using human body communication in accordance with an embodiment of the present invention.

### MODE FOR THE INVENTION

The advantages, features and aspects of the invention will become apparent from the following description of the embodiments with reference to the accompanying drawings, which is set forth hereinafter. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

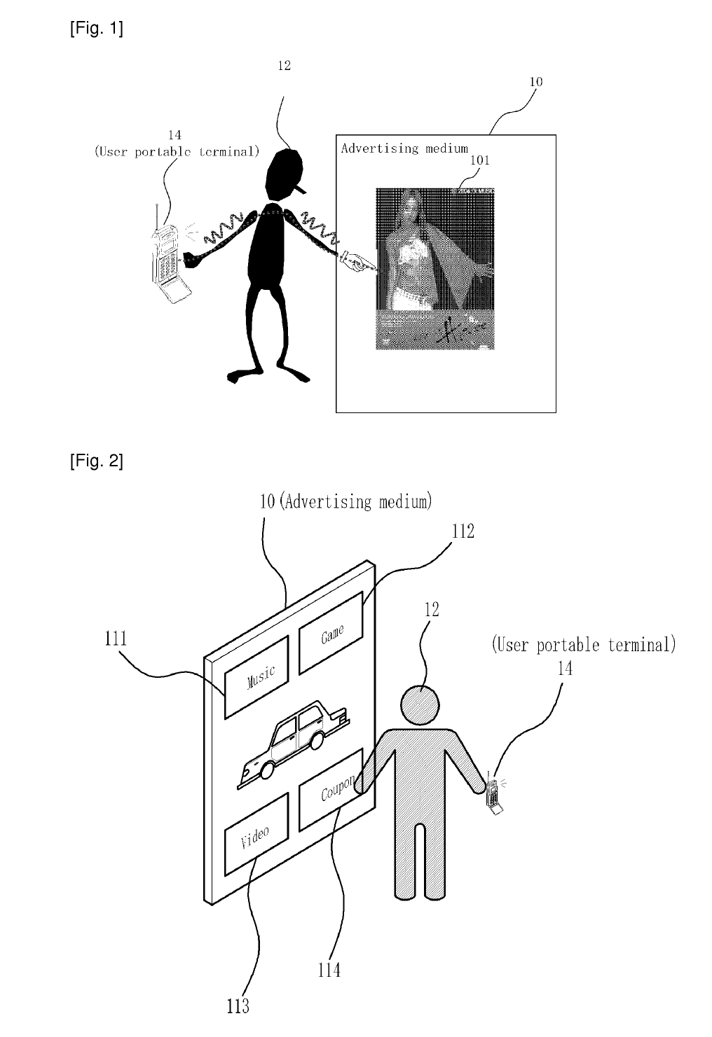

FIGS. 1 and 2 are views for explaining a media advertisement service using human body communication in accordance with an embodiment of the present invention. In FIG. 1, an advertising medium is an electronic display board, and in FIG. 2, an advertising medium is an advertising poster.

In accordance with an embodiment of the present invention, as a user 12 contacts a specific portion 101 or 111 to 114 of an advertising medium 10 of the electronic display board or the poster which the user is interested in, the user can download contents associated with an advertisement (hereinafter, referred to as advertisement-associated contents) such as music, a game, a coupon, a video or a picture through human body communication. Thus, the user 12 can download the advertisement-associated contents to a user portable terminal 14 through the human body communication only by touching the advertising medium 10 such as the electronic display board.

In accordance with an embodiment of the present invention, a conductive contact part detects user's contact. If conductive contact parts are installed at various places 111 to 114, the user can be provided with a variety of advertisement-associated contents.

That is, if a plurality of conductive contact parts attached to one advertising medium, a variety of advertisement-associated contents can be offered from even one advertising medium. For example, a mini game may be transmitted if a user touches a right upper corner of an advertising poster, and a demo song may be transmitted if the user touches a left lower corner. This concept may be applied for a treasure hunt to induce users' interests, leading to participation of more users.

An exemplary embodiment of the present invention will now be described.

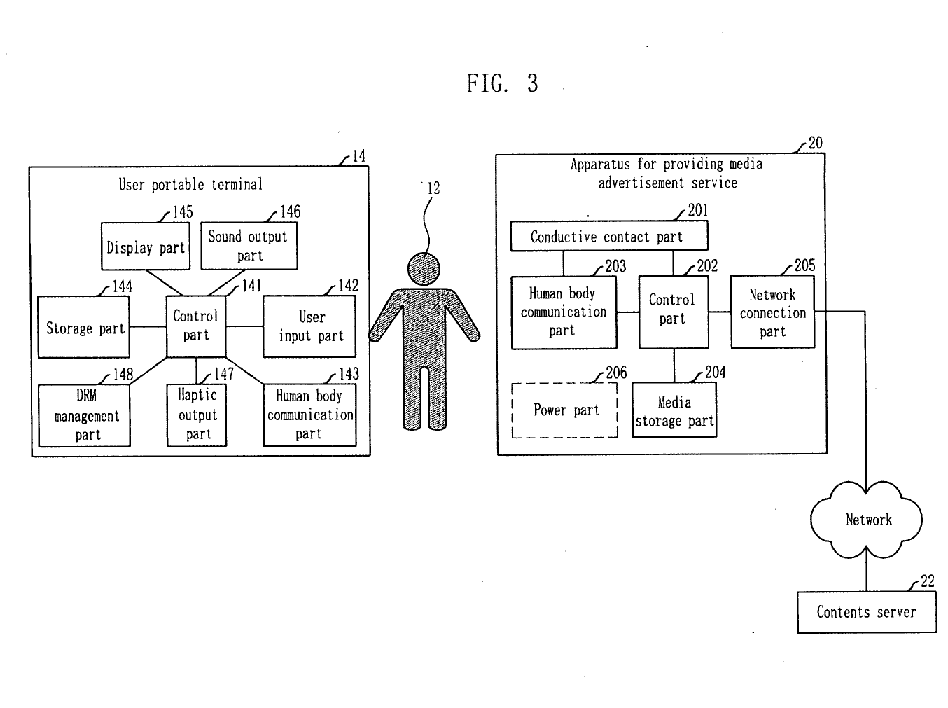

A movie advertising medium, e.g., a media distribution system looking like a plasma display panel (PDP) TV employing an embodiment of the present invention (see FIG. 3) is installed at a subway station. A conductive surface, i.e., a conductive contact part 201 of FIG. 3 is disposed at a specific coordinate of a display screen. The conductive surface is configured into a label type, and is not distinctive to the naked eye. The label type conductive surface may be attached to an advertising screen to provide services such as a spider-man cell-phone game, a spider-man soundtrack, a spider-man movie ticket discount coupon, a movie trailer download, and a movie ticket reservation.

A trailer of spider-man may be played back on an advertising medium screen, or a poster of spider-man may be displayed thereon. If a user with a user portable terminal 14 is interested in such a spider-man advertisement, the user presses a touch and play button of the user portable terminal 14 with one hand, while touching a label, i.e., a conductive contact part of the advertising medium with another hand.

Then, the user portable terminal 14 receives, i.e., downloads advertisement-associated contents data via the body of the user, making audio feedback such as a bell sound or haptic feedback such as vibration or displaying a process status on a terminal screen.

If the user receives the movie trailer, the trailer is stored in a storage part 114 of FIG. 3 of the user portable terminal 14, and is played back upon the user's selection.

For a soundtrack among the advertisement-associated contents provided by the apparatus 20 of FIG. 3 for providing a media advertisement service in accordance with an embodiment of the present invention, digital rights management (DRM) is used to limit playback thereof to a predetermined period, e.g., 3 days or a predetermined number of times, e.g., total 5 times. If the playback is disabled as the predetermined condition such as the period or the number of times expires, a new playback condition may be set by user re-touching the corresponding advertising board.

For a movie ticket discount coupon among the advertisement-associated contents, the portable terminal 14 may store the coupon as a picture file readable by a barcode reader.

If the user selects “movie ticket reservation” by touching, an Internet address (URL) of a homepage for movie ticket reservation may be transferred to the user portable terminal 14, so that the user can reserve a movie ticket.

In accordance with an embodiment of the present invention employed in a movie advertising medium, a media storage part 204 of FIG. 3 and a network connection part 205 of FIG. 3 are included. For this reason, to advertise the movie “spider-man” spider-man data can be downloaded from a contents server 22 of FIG. 3 for advertising. Also, to advertise the movie “superman” superman data can be downloaded from the contents server 22 of FIG. 3 for advertising.

FIG. 3 is a block diagram of an apparatus for providing a media advertisement service using human body communication in accordance with an embodiment of the present invention.

When a user touches a conductive contact part 201, the apparatus 20 for providing a media advertisement service using human body communication sends contents associated with an advertisement (hereinafter, referred to as advertisement-associated contents) corresponding to a contact position to a user portable terminal 14 through user body telecommunication.

The user portable terminal 14 will now be described.

The user portable terminal 14 may be one of various terminals including a human body communication module, which is an Rx/Tx module for human body communication. As shown in FIG. 3, the user portable terminal 14 includes a control part 141, a user input part 142, a human body communication part 143, a storage part 144, a display part 145, a sound output part 146, a haptic output part 147, a digital rights management (DRM) part 148. The user portable terminal 14 is basically identical to an existing portable terminal including a human body communication function.

Particularly, to inform a user of a process status of the human body communication, the user portable terminal 14 can make visual feedback, audio feedback, or haptic feedback using, e.g., magnitude or frequency of vibration.

Also, the user portable terminal 140 stores and manages a variety of contents collected through the human body communication in the storage part 144, facilitating management and playback of the advertisement-associated contents.

The apparatus 20 for providing a media advertisement service using human body communication in accordance with an embodiment of the present invention will now be described in detail, together with a method for providing a media advertisement service, which is performed in the apparatus 20 for providing a media advertisement service.

The apparatus 20 for providing a media advertisement service in accordance with an embodiment of the present invention includes a conductive contact part 201, a control part 202, a human body communication part 203, a media storage part 204, a network connection part 205, and a power part 206.

The conductive contact part 201 is a portion for human-body contact with a user. The conductive contact part 201 may be configured into a label type and attached to an advertising medium, e.g., to a specific location of an advertising poster or a specific coordinate on a screen of a display device. The conductive contact part 201 may be configured as a two-dimensional surface or a three-dimensional surface.

The control part 202 detects whether human body contact occurs from the user with the conductive contact part 201. If user's contact is detected, the control part 202 acquires contents associated an advertisement selected by the user's contact, i.e., an advertisement corresponding to a portion that the user touches. Hereinafter, such contents will be referred to as user-contact-associated contents. The user-contact-associated contents include advertisement-associated contents, a coupon, an access code for access to the advertisement-associated contents, and an Internet address such as an internet address of a reservation site or an Internet address of a contents purchase site.

That is, the control part 202 previously stores advertisement-associated contents in the media storage part 204. When detecting user's contact, the control part 202 searches the stored advertisement-associated contents for contents selected by a user, i.e., the user-contact-associated contents. Then, the control part 202 sends the user-contact-associated contents to the human body communication part 203.

In some embodiments, the apparatus for providing a media advertisement service may further include the network connection part 205 to access an external contents server 22. In this case, the control part 202 receives advertisement-associated contents from the contents server 22 via the network connection part 205, and stores the advertisement-associated contents in the media storage 204. When user's contact occurs, the control part 202 searches the stored advertisement-associated contents for contents selected by a user, i.e., user-contact-associated contents, and sends the user-contact-associated contents to the human body communication part 203. Particularly, whenever a new advertisement is displayed, the control part 202 receives and stores contents associated with the corresponding advertisement from the contents server 22.

In other embodiments, if detecting user's contact, then the control part 202 accesses the contents server 22 via the network connection part 205 to receive user-contact-associated contents and sends the contents to the human body communication part 202.

The human body communication part 203 performs reception/transmission for human body communication. Particularly, the human body communication part 203 converts the user-contact-associated contents acquired at the control part 202 into a signal for human body communication, and sends the signal toward the user's body 12 through the conductive contact part 201. The advertisement-associated contents are transmitted to the user portable terminal 14 via the use's body 12.

In case where an advertising medium is placed at a place where power supply is impossible, the power part 206 may be further provided in the apparatus 20 for providing a media advertisement service to overcome spatial limitations and provide a media advertisement service using human body communication.

In order to statistically analyze user groups interested in an advertisement and a contact frequency of users, the control part 202 acquires user contact information for each advertisement, and stores therein the user contact information or sends the user contact information to the contents server 22 via the network connection part 205. It can be considered that the number of times that users contact, i.e., react to an advertisement proportionally reflects an effect of the advertisement. Thus, this may allow an advertiser to differentially pay for an advertisement depending on an advertising effect.

With reference to FIG. 3, there has been described the apparatus 20 for providing a media advertisement service including the label type conductive contact part 201, which is attachable to a separate advertising medium such as an advertisement poster. However, in some embodiments, the apparatus 20 for providing a media advertisement service may include a display part (not shown) including a conductive contact part. The display part may include a conductive touch panel on its surface for human body communication.

Since the apparatus 20 for providing a media advertisement service includes the display part including the conductive contact part for human body communication, the apparatus 20 for providing a media advertisement service can perform both an advertisement display function and a human body communication function using human body contact.

In an embodiment of the present invention, a telecommunication technology where a data transmission distance is limited to approximately 10 cm is used. Examples of such a telecommunication technology include human body communication, near-field communication, ultra-wide band (UWB) communication, and radio frequency identification (RFID) communication.

As described above, the technology of the present invention can be realized as a program. Codes and code segments constituting the program can be easily construed by programmers skilled in the art to which the present invention pertains. The program is stored in a computer-readable recording medium, i.e., an information storage medium, and executed to realize the technology of the present invention. Examples of the computer-readable recording medium include all types of computer-readable recording media.

The present application contains subject matter related to Korean Patent Application Nos. 2006-0123237 and 2007-0112210 filed in the Korean Intellectual Property Office on Dec. 6, 2006, and Nov. 5, 2007, respectively, the entire contents of which is incorporated herein by reference.

While the present invention has been described with respect to certain preferred embodiments, it will be apparent to those skilled in the art that various changes and modifications may be made without departing from the scope of the invention as defined in the following claims.

1. An apparatus for providing a media advertisement service using human body communication, comprising:
a conductive contact part for contact with a human body;
a control part configured to detect human body contact of a user with the conductive contact part and acquire user-contact-associated contents, the user-contact-associated-contents being contents associated with an advertisement selected by the human body contact of the user; and
a human body communication part configured to convert the acquired user-contact-associated contents into a signal for human body communication and send the signal to a user terminal via the conductive contact part and a user's body.

2. The apparatus of claim 1, wherein the conductive contact part is a label type attachable to an advertising medium.

3. The apparatus of claim 1, wherein the conductive contact part is placed at a specific coordinate on a screen of an external display device.

4. The apparatus of claim 1, further comprising a display part configured to display an advertisement, the display part being integral with the conductive contact part.

5. The apparatus of claim 1, wherein the control part previously stores advertisement-associated contents,
wherein when the control part detects human body contact of the user, the control part searches the stored advertisement-associated contents to acquire the user-contact-associated contents.

6. The apparatus of claim 1, further comprising a network connection part configured to access an external contents server.

7. The apparatus of claim 6, wherein the control part receives advertisement-associated contents from the contents server via the network connection part and stores the received advertisement-associated contents,
wherein when the control part detects human body contact of the user, the control part searches the stored advertisement-associated contents to acquire the user-contact-associated contents.

8. The apparatus of claim 7, wherein whenever a new advertisement is displayed, the control part receives corresponding advertisement-associated contents from the contents server.

9. The apparatus of claim 6, wherein when the human body contact of the user is detected, the control part accesses the contents server and receives user-contact-associated contents corresponding to the detected human body contact of the user.

10. The apparatus of claim 1, wherein the control part acquires information of a user access frequency for each advertisement.

11. The apparatus of claim 6, wherein the control part acquires information of a user access frequency for each advertisement, and sends the information to the contents server via the network connection part.

12. The apparatus of claim 1, wherein the user-contact-associated contents include at least one of advertisement contents, a coupon, an access code for access to corresponding advertisement contents, and an Internet address.

13. A method for providing a media advertisement service using human body communication, comprising the steps of:
detecting human body contact of a user with an advertising medium;
acquiring user-contact-associated contents when the user's contact is detected, the user-contact-associated contents being contents associated with an advertisement selected by the user's contact; and
converting the acquired user-contact-associated contents into a signal for human body communication and sending the signal to a user terminal through human body communication.

14. The method of claim 13, wherein the step of detecting the human body contact includes the step of:
detecting human body contact through a conductive contact part attached to the advertising medium.

15. The method of claim 13, wherein the step of acquiring the user-contact-associated contents includes the step of:
searching previously stored advertisement-associated contents to acquire the user-contact-associated contents.

16. The method of claim 15, wherein the step of acquiring the user-contact-associated contents includes the step of:
receiving advertisement-associated contents from a contents server whenever a new advertisement is displayed, and storing the received advertisement-associated contents.

17. The method of claim 13, wherein the step of acquiring the user-contact-associated contents includes the step of:
accessing a contents server when the human body contact of the user is detected to acquire user-contact-associated contents corresponding to the human body contact of the user.

18. The method of claim 13, further comprising the step of:
acquiring information of a user access frequency for each advertisement and sending the information to a contents server.
